(19) United States
(12) Patent Application Publication
(10) Pub. No.: US 2010/0130356 A1
(43) Pub. Date: May 27, 2010

(54) Thermally-responsive record material

(75) Inventors: Mark Robert Fisher, Appleton, WI (US); Joseph Peter Gusse, Appleton, WI (US)

Correspondence Address: APPLETON PAPERS INC.;LAW DEPARTMENT, 825 E. WISCONSIN AVENUE, PO BOX 359, APPLETON, WI, 54912-0359, US

(73) Assignee: Appleton Papers Inc., Appleton, WI (US)

(21) Appl. No.: 12/590,904

(22) Filed: Nov. 16, 2009

Related U.S. Application Data
(60) Provisional application No. 61/199,899, filed on Nov. 21, 2008.

(51) Int. Cl. B41M 5/323; B41M 5/333

(52) U.S. Cl. 503/217

(57) ABSTRACT

A thermally-responsive record material useful for bar coding is taught comprising a support having provided thereon in substantially contiguous relationship a heat sensitive coating comprising at least one chromogenic material, said chromogenic material being selected from a fluoran, and at least one developer of the formula (II)

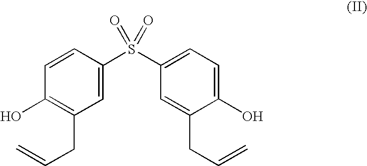

wherein the chromogenic material and developer are of an average particle size equal to or less than 0.7 μm meters, wherein the composition is substantially free of sensitizer or modifier. The record material of the invention remarkably images at high speed, with stable or intense imaging and little or no background discoloration.

This application claims priority to U.S. Provisional Application Ser. No. 61/199,899 filed Nov. 21, 2008.

### BACKGROUND OF THE INVENTION

1. Field of the Invention

This invention relates to a thermally-responsive record material. It more particularly relates to such record material in the form of sheets coated with color-forming systems comprising chromogenic material (electron-donating dye precursors) and acidic color developer material. This invention particularly concerns a thermally-responsive record material (thermal record material) capable of forming a substantially non-reversible image with improved color-forming efficiency and/or image density.

2. Description of the Background Art

Thermally-responsive record material systems are well known in the art and are described in many patents, for example: U.S. Pat. Nos. 3,539,375; 3,674,535; 3,746,675; 4,151,748; 4,181,771; 4,246,318 and 4,470,057 which are incorporated herein by reference. In these systems, basic chromogenic material and acidic color developer material are contained in a coating on a substrate which, when heated to a suitable temperature, melts or softens to permit said materials to react, thereby producing a colored mark.

Thermally-responsive record materials have characteristic thermal responses, desirably producing a color image upon selective thermal exposure.

In the field of thermally-responsive record material, thermal response is defined as the temperature at which a thermally-responsive record material produces a colored image of sufficient intensity (density). The desired temperature of imaging varies with the type of application of the thermally-responsive product and the equipment in which the imaging is to be performed.

Desirable features include the ability of a thermally-responsive record material to have improved imaging characteristics such as enhanced image intensity, image density, image retention, image stability, or improved thermal response. Modern thermal printers require ever increasing imaging speeds. Particularly in bar code applications stability of the image and white background or low background discoloration is a sought after feature for thermally imaging record materials particularly direct thermal record materials.

Traditionally, sensitizers have been used to reduce the activator temperature and to allow for high speed lower energy printing. Although sensitizers allow for higher imaging speeds, in practice the lowering of the activation temperature is often accompanied by a more active background meaning the background is more susceptible to discoloration at lower environmental temperatures as well. Such background discoloration can lead to impeding of barcode scanability or give rise to misreads or failure to read the barcode. Because sensitizers tend to be volatile materials, these materials also can cause fading of the image giving rise to additional impediments to quality barcode scanning.

Prior art thermally responsive record systems have the common drawback that the image erases when the color-forming layer is subjected to various environmental challenges. Some systems try to overcome the problem by isolating or overcoating the color-forming layer. Such solutions however add expense, processing steps and are prone to premature erasure if the isolation means is compromised by wear or other reasons. A more stable chemistry is a particular sought after characteristic.

### SUMMARY OF THE INVENTION

A thermally-responsive record material is disclosed which is useful for bar coding comprising a support having provided thereon in substantially contiguous relationship a heat sensitive coating comprising at least one chromogenic material, said chromogenic material being selected from compounds of the formula (I)

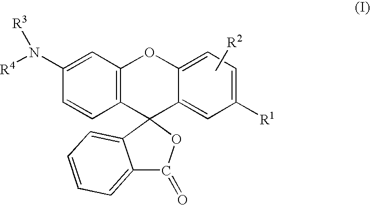

wherein R¹ comprise amino-, nitro-, hydrogen, C1 to C8 alkyl, anilino, dialkylanilino, aniline substituted with halogen, acetamido, or halogen;
wherein R² comprises hydrogen or C1 to C8 alkyl;
wherein R³ and R⁴ each independently comprise alkaryl, cycloalkyl, or C1 to C8 alkyl; and at least one developer of the formula (II)

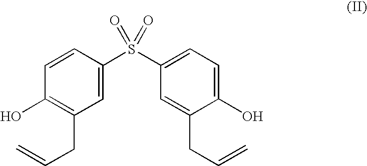

wherein the chromogenic material and developer are of an average particle size of less than 5×10⁻⁷ meters, wherein the composition is substantially free of sensitizer or modifier.

Preferably but optionally the thermally-responsive record material can include in addition a topcoat selected from materials such as polyvinyl alcohol, carboxylated polyvinylalcohol, methylcellulose, ethyl cellulose, polyacrylamide, gelatin, starch, polyvinyl pyrrolidone, and the like. A backcoat is also optional.

In a preferred embodiment of the thermally-responsive record material the chromogenic material is a fluoran, and preferably 3-dibutylamino-6-methyl-7-anilino fluoran.

In the invention, unlike in conventional systems, a sensitizer such as a material selected from 1,2-diphenoxyethane, acetoacet-o-toluidine, phenyl-1-hydroxy-2-naphthoate, and p-benzyl biphenyl is preferably omitted, such that the record material is substantially free of sensitizer or modifier.

In a further embodiment, the thermally-responsive record material color-forming composition can comprise one or more layers coated on the support, such as paper. For example, the chromogenic material or developer can be positioned in a separate layer from the compound of formula II. All such variations are within the scope of the invention contemplated herein and are considered contiguous for purposes hereof.

### DETAILED DESCRIPTION

The present invention is a novel thermally-responsive record material comprising a substrate having coated thereon, in substantially contiguous relationship, a thermally-sensitive color-forming composition as a heat sensitive layer comprising a chromogenic material, and an acidic developer material whereby the melting or sublimination of the material produces a change in color reaction.

The invention described in detail herein is a thermally-responsive record material useful for bar coding comprising a support having provided thereon in substantially contiguous relationship a heat sensitive coating comprising at least one chromogenic material, said chromogenic material being selected from compounds of the formula (I)

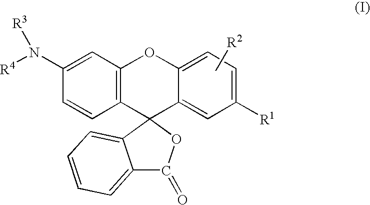

wherein R¹ comprise amino-, hydrogen, alkyl having less than nine carbons, anilino, anilino substituted with halogen, acetamido, or halogen;
wherein R² comprises hydrogen or C1 to C8 alkyl;
wherein R³ and R⁴ each independently comprise hydrogen, dialkylaminoaryl, alkaryl, cycloalkyl, or C1 to C8 alkyl and at least one developer of the formula (II)

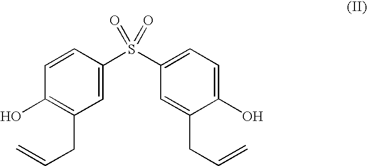

wherein the chromogenic material and developer are of an average particle size of less than 5×10⁻⁷ meters (0.5 μm), wherein the composition is substantially free of sensitizer or modifier.

Surprisingly, the intensity of the image and percent loss after environmental challenges are substantially improved as compared to other systems including most surprisingly, in comparison to systems which include sensitizers or modifiers.

Conventional teachings relating to thermally responsive record materials consisting teach and require the desirability for inclusion of a sensitizer or modifier material. The sensitizer or modifier typically does not impact any image on its own and is not considered active in the formation of color but as a relatively low melting solid acts as a solvent to facilitate reaction of the mark forming components. Sensitizers are described in U.S. Pat. No. 4,531,140 incorporated herein by reference.

The art teaches a variety of sensitizers including fatty acid amides such as stearic acid amide, methylenebis stearic acid amide, oleic acid amide, palmitic acid amide, coconut aliphatic acid amide and the like; hindered phenols such as 2,2′-methylenebis (4-methyl-6-tert-butylphenyl), 4,4′-butylidenebis (6-tert-butyl-3-methylphenol), 2,2′-methylenebis (4-ethyl-6-tert-butylphenol), 2,4-di-tert-butyl-3-methylphenol, 2-hydroxy-4-benzyloxy-benzophenone, 1,2-di(3-methylphenoxy)ethane, 1,2-diphenoxyethane, 1-phenoxy-2-(4-methylphenoxy)ethane, naphthyl benzyl ether, benzyl-4-methyl thiophenyl ether, dimethyl terephthalate, dibutyl terephthalate, dibenzyl terephthalate, dibutyl isophthalate, phenyl 1-hydroxy-naphthoate, benzyl-4-methyl thiophenyl ether. 1,2-di(3-methylphenoxy)ethane, 1,2-diphenoxyethane, 1-phenoxy-2-(4-methylphenoxy)ethane are generally preferred sensitizers. Conventionally, the usage amount of the sensitizer is adjusted within the range of not more than 4 parts by weight per one part by weight of the color developer. Surprisingly, the invention eliminates the need for use of sensitizer materials, yet provides an intense stable image which forms rapidly at relatively low activation temperatures.

As the coating methods, there may be used various known means such as air-knife coating, rod-blade coating, dipping, roll application, reverse roll, wire wound rod, bill-blade coating, short-dwell time coating, curtain coating, slot die, slide curtain, Mayer rod, knife over roll, spraying and the like. The amount of the applied coating composition is not also particularly limited, but it is generally controlled within the range of 2 to 12 g/m2, preferably 3 to 10 g/m2 on a dry basis.

The developer of the formula (II)

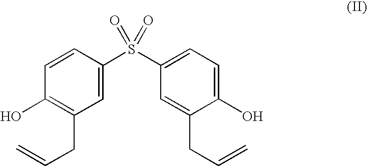

and the chromogenic material and developer are of an average particle size equal to or less than 0.5 μm.

Compound II, bis(4-hydroxy-3-allylphenyl) sulphone is available commercially from vendors such as Nippon Kayaku Co., Ltd. (Trademark: “TGSA”). This material also can be synthesized from starting materials of 4,4′-sulfonyldiphenol or its alkali metal salt with a halogenated allyl compound in the presence of catalyst. The resultant material is heated in excess of 200° C. for a rearrangement to form the final product.

Other synthetic routes to bis(4-hydroxy-3-allylphenyl) sulphone are described in patents such as U.S. Pat. Nos. 6,114,282 and 4,596,997 incorporated herein by reference.

One route to compound II is by reacting 4,4′-sulfonyldiphenol (25 parts) with allyl-p-toluene sulfonate (44 parts) in the presence of potassium carbonate (15.2 parts) in a solvent such as dimethylformamide (100 parts). Heat at 110° for 8 hours. Distill the solvent, heating and stirring at 200° C. for 6 hours. Add 60 parts trichlorobenzene and cool to ambient temperature with stirring. Filter to recover precipitated bis(4-hydroxy-3-allylphenyl) sulphone.

Other synthetic routes would be apparent to the artisan having skill in the synthetic arts.

The invention comprises a thermally sensitive color-forming composition comprising electron donating dye precursor (chromogenic material) and acidic developer material compromising a combination of compounds I and II and binder material. The unexpected feature of this composition is that the inclusion of the combination of compounds of the invention facilitates the color-forming reaction resulting in stable image, a more intense image or faster imaging even in the absence of sensitizer. The image is resistant to fade when subjected to common environmental challenges such as lotion or oil. The record material according to the invention has a non-reversible image in that under normal use conditions such as a record of a transaction, it is substantially non-reversible and stable for many months or even years. The coating of the record material of the invention is basically a dewatered solid at ambient temperature and differs from reversible solvent liquid based compositions such as taught by Kito et al., in U.S. Pat. Nos. 4,720,301 and 4,732,810 which erase upon exposure to elevated temperature from 20° C. to 50° C. The image herein formed is non-reversible at such temperature. The color-forming composition (or system) of the record material of this invention comprises chromogenic material (electron-donating dye precursor) in its substantially colorless state, and acidic developer material comprising the combination of compounds I and II. The color-forming system relies upon melting, softening, or subliming one or more of the components to achieve reactive, color-producing contact.

The record material includes a substrate or support material which is generally in sheet form. For purposes of this invention, sheets can be referred to as support members and are understood to also mean webs, ribbons, tapes, belts, films, cards and the like. Sheets denote articles having two large surface dimensions and a comparatively small thickness dimension. The substrate or support material can be opaque, transparent or translucent and could, itself, be colored or not. The material can be fibrous including, for example, paper and filamentous synthetic materials. It can be a film including, for example, cellophane and synthetic polymeric sheets cast, extruded, or otherwise formed. Various kinds or types of substrate material may be used.

The components of the color-forming system are in substantially contiguous relationship, substantially homogeneously distributed throughout the coated layer or layers of material deposited on the substrate.

The term substantially contiguous relationship is understood to mean that the color-forming components are positioned in sufficient proximity such that upon melting, softening or subliming one or more of the components a reactive color-forming contact between the components is achieved. As is readily apparent to the person of ordinary skill in the art, these reactive components accordingly can be in the same coated layer or layers which is preferred, or isolated or positioned in separate layers. In other words, one component such as the chromogen can be positioned in the first layer, and developer positioned in a subsequent layer or layers. The coating can optionally be applied to all of the substrate or spot printed on a certain portion. All such arrangements are understood herein as being “substantially contiguous” and would be readily apparent to the skilled artisan.

The thermal record material can optionally include a variety of precoats such as a base layer of clay, and absorptive pigments such as kaolin clays, insulators such as hollow sphere particles, pigments, particulate clays, starch, or synthetic polymeric materials. Hollow sphere particles are commercially available such as the “Ropaque” materials of Rohm and Haas.

Optionally, the thermally-sensitive color-forming composition can be formed as a top layer on the substrate which top layer is then overcoated with a protective layer top coat or barrier layer formed from one or more water soluble or dispersible polymeric materials such as polyvinyl alcohol, carboxylated polyvinyl alcohol, methyl or ethyl cellulose, polyacrylamide, gelatin, starch or polyvinyl pyrrolidone.

The components of the heat sensitive coating are reduced to an average partial size approaching nanoparticles. The chromogenic material and the developer are comminuted to an average particle size of less than 0.5 μm, more preferable 2 μm or less.

Surprisingly, at such submicron sizes, reactivity increases eliminating need for addition of sensitizer, yet producing as intense an image with higher stability and little to no background discoloration.

The effect was seen to be particularly pronounced when the chromogenic material was selected to be 2-anilino-3-methyl-6-dibutylaminofluoran. In formula I, for this material R³ and R⁴ are butyl, R² is methyl at the 3 position of the ring and R′ is anilino. This material is also available in alternate crystal forms α and B as described in assignee Yamamoto, U.S. Pat. No. 5,110,952 and earlier U.S. Pat. No. 4,510,513 assigned to Hodogaya Chemical and Nippon Kayaku, Japanese Laid Open Patent 60-202155, Oct. 12, 1985. For purposes hereof, when referring to 2-anilino-3-methyl-6-dibutylaminofluoran, either or both crystalline forms are intended.

Optionally, a protective layer using the same or different materials can be applied as a back coat to the thermally-sensitive record material. The materials indicated as useful as precoats, such as the hollow sphere particles, pigments, clays and synthetic polymeric particulate materials can also be usefully applied as the back coat.

In manufacturing the record material, a coating composition is prepared which includes a fine dispersion of the components of the color-forming system, polymeric binder material, surface active agents and other additives in an aqueous coating medium. The color-forming composition can additionally contain inert pigments, such as clay, talc, aluminum hydroxide, calcined kaolin clay and calcium carbonate; synthetic pigments, such as urea-formaldehyde resin pigments; natural waxes such as Carnuba wax; synthetic waxes; lubricants such as a zinc stearate; wetting agents; defoamers, and antioxidants.

The color-forming system components are substantially insoluble in the dispersion vehicle (preferably water). The polymeric binder material is substantially vehicle soluble although latexes are also eligible in some instances. Preferred water soluble binders include polyvinyl alcohol, hydroxy ethyl-cellulose, methylcellulose, methyl-hydroxypropylcellulose, starch, modified starches, gelatin and the like. Eligible latex materials include polyacrylates, sytrene-butadiene-rubber latexes, polyvinylacetates, polystyrene, and the like. The polymeric binder is used to protect the coated materials from brushing and handling forces occasioned by storage and use of thermal sheets. Binder should be present in an amount to afford such protection and in an amount less than will interfere with achieving reactive contact between color-forming reactive materials.

Coating weights can effectively be about 3 to about 9 grams per square meter (gsm) and preferably about 5 to about 6 gsm. The practical amount of color-forming materials is controlled by economic considerations, functional parameters and desired handling characteristics of the coated sheets.

Fluorans according to formula I include: 3-diethylamino-6-methyl-7-anilino-fluoran (U.S. Pat. No. 4,510,513) also known as 3-dibutylamino-6-methyl-7-anilino-fluoran; 3-dibutylamino-7-(2-chloroanilino) fluoran 7-(1-ethyl-2-methylindol-3-yl)-7-(2-chloroanilino) fluoran (U.S. Pat. No. 3,920,510); 3-(N-methylcyclohexylamino)-6-methyl-7-anilinofluoran (U.S. Pat. No. 3,959,571); 3-diethylamino-7-anilinofluoran; 3-diethylamino-7-benzylaminofluoran; 3-2,4-dimethyl-6[(4-dimethylamino)aniline]-fluoran, 2-anilino-3-methyl-6-dibutylaminofluoran and mixtures of any of the above. These fluorans are substantially colorless dye precursors.

The developer is preferably bis(4-hydroxy-3-allylphenyl)sulphone.

Other known developer materials may also be included provided not used in an amount so as to detract from the functionality of the combination of the invention. Other acidic developer materials include the compounds listed in U.S. Pat. No. 3,539,375 as phenolic reactive material, particularly the monophenols and diphenols. Acidic developer materials also include, the following compounds: 4,4′-isopropylidinediphenol (Bisphenol A); p-hydroxybenzaldehyde; p-hydroxybenzophenone; p-hydroxypropiophenone; 2,4-dihydroxybenzophenone; 1,1-bis(4-hydroxyphenyl)cyclohexane; salicyanilide; 4-hydroxy-2-methylacetophenone; 2-acetylbenzoic acid; m-hydroxyacetanilide; p-hydroxyacetanilide; 2,4-dihydroxyacetophenone; 4-hydroxy-4′-methylbenzophenone; 4,4′-dihydroxybenzophenone; 2,2-bis(4-hydroxyphenyl)-4-methylpentane; benzyl 4-hydroxyphenyl ketone; 2,2-bis(4-hydroxyphenyl)-5-methylhexane; ethyl-4,4-bis(4-hydroxyphenyl)-pentanoate; isopropyl-4,4-bis(4-hydroxyphenyl)pentanoate; methyl-4,4-bis(4-hydroxyphenyl) pentanoate; alkyl-4,4-bis(4-hydroxyphenyl) pentanoate; 3,3-bis(4-hydroxyphenyl)(-pentane; 4,4-bis(4-hydroxyphenyl)-heptane; 2,2-bis(4-hydroxypheyl)-1-phenylpropane; 2,2-bis(4-hydroxyphenyl)butane; 2,2′-methylene-bis(4-ethyl-6-tertiarybutyl phenol); 4-hydroxycoumarin; 7-hydroxy-4-methylcoumarin; 2,2′-methylene-bis(4-octyl phenol); 4,4′-sulfonyldiphenol; 4,4′-thiobis(6-tertiarybutyl-m-cresol); methyl-p-hydroxybenzoate; n-propyl-p-hydroxybenzoate; and benzyl-p-hydroxybenzoate.

Examples of other developer compounds include phenolic novolak resins which are the product of reaction between, for example, formaldehyde and a phenol such as an alkylphenol, e.g., p-octylphenol, or other phenols such as p-phenylphenol, and the like; and acid mineral materials including colloidal silica, kaolin, bentonite, aftapulgite, hallosyte, and the like. Some of the polymers and minerals do not melt but undergo color reaction on fusion of the chromogen.

The following examples are given to illustrate some of the features of the present and should not be considered as limiting. In these examples all parts or proportions are by weight and all measurements are in the metric system, unless otherwise stated.

In all examples illustrated in the present invention, a dispersion of a particular system component, was prepared by deposition or recrystallization or by milling the component in an aqueous solution of the binder until a particle size of 5×10⁻⁷ (0.5 μm) meters or less was achieved. An attritor or other suitable device can be used for milling. The desired average particle size was 5×10⁻⁷ meters (0.5 μm) or less and preferably 0.2 μm or less in each dispersion. μm is understood as a micron.

The submicron, nano-like particulates and suspensions of the materials of the invention can be manufactured through several techniques. One technique can involve crystal precipitation. In this technique crystals are grown dissolved in solvent. A non-solvent is added to course precipitation or crystallization. Alternative techniques rely on milling or wet milling to achieve submicron particles. With these techniques the crystals are intentionally fractured and comminuted to particles smaller than the crystal size of initial formation, which varies from material to material.

As sizes decrease, various effects not seen with larger particulates are expressed, most notability intense image density in the surprising absence of sensitizer or modifier.

Particulates in the necessary sizes to express these effects can be produced by aerosol methods, or chemical mechanical grinding, (meaning reducing the physical size of). This may entail a ball mill, rod mill, SAG mill, autogenous mill, pebble mill or other means of grinding or comminuting to submicron sizes. In some embodiments the material may be subjected to one or more heating steps during grinding. It is contemplated that grinding or comminuting can be conducted under ambient conditions, under an inert gas, or at elevated temperature or even in the presence of a liquid chemical agent to facilitate small particle formation. The optional liquid medium can include a solvent, surfactant, or lubricant.

Formation of nano type or nano-like particles can involve physical and chemical methods. Physical methods include, for example, electrospray, ultrasound, spray drying, superior fluid, solvent/anti-solvent crystallization and cryogenic technology. Electrospraying is disclosed in U.S. Pat. No. 3,208,951; ultrasound techniques are disclosed in U.S. Pat. No. 5,389,379 and supercritical carbon dioxide methods are disclosed in U.S. Pat. No. 5,639,441, U.S. Pat. No. 6,095,134 and U.S. Pat. No. 6,630,121; spray drying using compressed air is disclosed in U.S. Pat. No. 6,582,285 and U.S. Pat. No. 6,431,478. In addition, emulsion polymerization, interface polymerization and coagulation/phase separation can be used to fabricate nanoparticles. The above patents are incorporated herein to the extent that they provide exemplary, procedural or other details supplementary to those set forth herein.

All patents, test procedures, and other documents cited herein, including priority documents, are fully incorporated by reference to the extent such disclosure is not inconsistent with this invention and for all jurisdictions in which such incorporation is permitted.

The thermally-responsive sheets were made by making a coating dispersion. The dispersion was applied to a support with a wire wound rod and dried. Other materials such as fillers, antioxidants, lubricants and waxes can be added to the dispersion if desired. The sheets may be calendered to improve smoothness.

The following examples are given to illustrate some of the features of the present invention and should not be considered as limiting. In these examples all parts or proportions are by weight and all measurements are in the metric system, unless otherwise stated.

Nontopcoated sheets with heat-sensitive emulsion can be made and exposed to oil and hand lotion containing α-hyroxyacid. A mixture of all active components can be made in the following manner:

| Components | Weight (g) |
|---|---|
| Fillers: | |
| calcium carbonates | 75 |
| amorphous silicon dioxide | 15 |
| Binder: | |
| Polyvinylalcohol | 150 |
| Zinc stearate | 5 |
| Stilbene fluorescent brightener | 1.3 |
| Chromogen: | |
| 3-Dibutylamino-6-methyl-7-anilinofluoran | 18 |

μm = microns

The above slurry is separated into 7 equal parts, each weighting 40 g. Developer blends with compound II added can be used to create variations.

| | Parts |
|---|---|
| Dispersion A - Chromogenic Material | |
| Chromogenic Material | 30.0 |
| Binder, 20% solution of Polyvinyl alcohol in water | 25.0 |
| Defoaming and dispersing agents | 0.4 |
| Water | 44.6 |
| Dispersion A1 - Chromogenic Material is ODB-2 @ 0.2 μm | |
| 3-Diethyamino-6-methyl-7-anilinofluoran | |
| Dispersion A2 - Chromogenic Material is ODB-2 @ 0.7 μm | |
| 3-Diethyamino-6-methyl-7-anilinofluoran | |
| Dispersion B - Acidic Material | |
| Acidic Material | 38.0 |
| Binder, 20% solution of Polyvinyl alcohol in water | 18.0 |
| Defoaming and dispersing agents | 0.4 |
| Water | 43.6 |
| Dispersion B1 - Acidic Material is TGSH @ 0.2 μm | |
| Bis(4-hydroxy-3-allylphenyl)sulphone | |
| Dispersion B2 - Acidic Material is TGSA @ 0.7 μm | |
| Bis(4-hydroxy-3-allylphenyl)sulphone | |
| Dispersion C - Sensitizing Material | |
| Sensitizing Material | 42.0 |
| Binder, 20% solution of Polyvinyl alcohol in water | 21.0 |
| Defoaming and dispersing agents | 0.4 |
| Water | 36.6 |
| Dipersion C1 - Sensitizing Material is DPE | |
| 1,2-Diphenoxyethane | |

| Coating Formulation 1 | Parts |
|---|---|
| Dispersion A (Chromogenic) | 20.0 |
| Dispersion B (Acidic) | 40.0 |
| Binder, 10% solution of polyvinylalcohol in water | 25.0 |
| Filler slurry, 30% in water | 15.0 |

### Example 1

### Coating Formulation 1 Using

### Dispersion A1 (ODB-2 @ 0.2 μm)

### Dispersion B1 (TGSH @ 0.2 μm)

### Example 2

### Coating Formulation 1 Using

### Dispersion A2 (ODB-2 @ 0.7 μm)

### Dispersion B2 (TGSH @ 0.7 μm)

### Example 3

### Coating Formulation 1 Using

### Dispersion A2 (ODB-2 @ 0.2 μm)

### Dispersion B2 (BSFD @ 0.2 μm)

### Example 4

### Coating Formulation 1 Using

### Dispersion A2 (ODB-2 @ 0.7 μm)

### Dispersion B2 (BSFD @ 0.7 μm)

### Example 5

### Coating Formulation 1 Using

### Dispersion A2 (ODB-2 @ 0.2 μm)

### Dispersion B2 (D8 @ 0.2 μm)

### Example 6

### Coating Formulation 1 Using

### Dispersion A2 (ODB-2 @ 0.7 μm)

### Dispersion B2 (D8 @ 0.7 μm)

### Example 7

### Coating Formulation 1 Using

### Dispersion A2 (ODB-2 @ 0.2 μm)

### Dispersion B2 (DP-201 @ 0.2 μm)

### Example 8

### Coating Formulation 1 Using

### Dispersion A2 (ODB-2 @ 0.7 μm)

### Dispersion B2 (DP-201 @ 0.7 μm)

### Example 9

### Coating Formulation 1 Using

### Dispersion A2 (ODB-2 @ 0.2 μm)

### Dispersion B2 (BPA @ 0.2 μm)

### Example 10

### Coating Formulation 1 Using

### Dispersion A2 (ODB-2 @ 0.7 μm)

### Dispersion B2 (BPA @ 0.7 μm)

### Example 11

### Coating Formulation 1 Using

### Dispersion A2 (ODB-2 @ 0.2 μm)

### Dispersion B2 (BPS-MAE @ 0.2 μm)

### Example 12

### Coating Formulation 1 Using

### Dispersion A2 (ODB-2 @ 0.7 μm)

### Dispersion B2 (BPS-MAE @ 0.7 μm)

### Example 13

### Coating Formulation 1 Using

### Dispersion A2 (ODB-2 @ 0.2 μm)

### Dispersion B2 (BPS-BN @ 0.2 μm)

### Example 14

### Coating Formulation 1 Using

### Dispersion A2 (ODB-2 @ 0.7 μm)

### Dispersion B2 (BPS-BN @ 0.7 μm)

### Example 15

### Coating Formulation 1 Using

### Dispersion A2 (ODB-2 @ 0.2 μm)

### Dispersion B2 (UU @ 0.2 μm)

### Example 16

### Coating Formulation 1 Using

### Dispersion A2 (ODB-2 @ 0.7 μm)

### Dispersion B2 (UU @ 0.7 μm)

| Comparative Formulation | Parts |
|---|---|
| Dispersion A (Chromogenic) | 20.0 |
| Dispersion B (Acidic) | 40.0 |
| Dispersion C (Sensitizing) | 15.0 |
| Binder, 10% solution of polyvinylalcohol in water | 25.0 |
| Filler slurry, 50% in water | 15.0 |

### Comparative Example 1

### Coating Formulation 1 Using

### Dispersion A1 (ODB-2 @ 0.2 μm)

### Dispersion B1 (TGSH @ 0.2 μm)

### Dispersion C1 (DPE)

### Comparative Example 2

### Coating Formulation 1 Using

### Dispersion A2 (ODB-2 @ 0.7 μm)

### Dispersion B2 (TGSH @ 0.7 μm)

### Dispersion C1 (DPE)

### Comparative Example 3

### Coating Formulation 1 Using

### Dispersion A2 (ODB-2 @ 0.2 μm)

### Dispersion B2 (BSFD @ 0.2 μm)

### Dispersion C1 (DPE)

### Comparative Example 4

### Coating Formulation 1 Using

### Dispersion A2 (ODB-2 @ 0.7 μm)

### Dispersion B2 (BSFD @ 0.7 μm)

### Dispersion C1 (DPE)

### Comparative Example 5

### Coating Formulation 1 Using

### Dispersion A2 (ODB-2 @ 0.2 μm)

### Dispersion B2 (D8 @ 0.2 μm)

### Dispersion C1 (DPE)

### Comparative Example 6

### Coating Formulation 1 Using

### Dispersion A2 (ODB-2 @ 0.7 μm)

### Dispersion B2 (D8 @ 0.7 μm)

### Dispersion C1 (DPE)

### Comparative Example 7

### Coating Formulation 1 Using

### Dispersion A2 (ODB-2 @ 0.2 μm)

### Dispersion B2 (DP-201 @ 0.2 μm)

### Dispersion C1 (DPE)

### Comparative Example 8

### Coating Formulation 1 Using

### Dispersion A2 (ODB-2 @ 0.7 μm)

### Dispersion B2 (DP-201 @ 0.7 μm)

### Dispersion C1 (DPE)

### Comparative Example 9

### Coating Formulation 1 Using

### Dispersion A2 (ODB-2 @ 0.2 μm)

### Dispersion B2 (BPA @ 0.2 μm)

### Dispersion C1 (DPE)

### Comparative Example 10

### Coating Formulation 1 Using

### Dispersion A2 (ODB-2 @ 0.7 μm)

### Dispersion B2 (BPA @ 0.7 μm)

### Dispersion C1 (DPE)

### Comparative Example 11

### Coating Formulation 1 Using

### Dispersion A2 (ODB-2 @ 0.2 μm)

### Dispersion B2 (BPS-MAE @ 0.2 μm)

### Dispersion C1 (DPE)

### Comparative Example 12

### Coating Formulation 1 Using

### Dispersion A2 (ODB-2 @ 0.7 μm)

### Dispersion B2 (BPS-MAE @ 0.7 μm)

### Dispersion C1 (DPE)

### Comparative Example 13

### Coating Formulation 1 Using

### Dispersion A2 (ODB-2 @ 0.2 μm)

### Dispersion B2 (BPS-BN @ 0.2 μm)

### Dispersion C1 (DPE)

### Comparative Example 14

### Coating Formulation 1 Using

### Dispersion A2 (ODB-2 @ 0.7 μm)

### Dispersion B2 (BPS-BN @ 0.7 μm)

### Dispersion C1 (DPE)

### Comparative Example 15

### Coating Formulation 1 Using

### Dispersion A2 (ODB-2 @ 0.2 μm)

### Dispersion B2 (UU @ 0.2 μm)

### Dispersion C1 (DPE)

### Comparative Example 16

### Coating Formulation 1 Using

### Dispersion A2 (ODB-2 @ 0.7 μm)

### Dispersion B2 (UU @ 0.7 μm)

### Dispersion C1 (DPE)

### Comparative Example 17

### Coating Formulation 1 Using

### Dispersion A2 (ODB-2 @ 0.2 μm)

### Dispersion B2 (BSFD @ 0.2 μm)

### Dispersion C1 (BON)

### Comparative Example 18

### Coating Formulation 1 Using

### Dispersion A2 (ODB-2 @ 0.7 μm)

### Dispersion B2 (BSFD @ 0.7 μm)

### Dispersion C1 (BON)

### Comparative Example 19

### Coating Formulation 1 Using

### Dispersion A2 (ODB-2 @ 0.2 μm)

### Dispersion B2 (D8 @ 0.2 μm)

### Dispersion C1 (BON)

### Comparative Example 20

### Coating Formulation 1 Using

### Dispersion A2 (ODB-2 @ 0.7 μm)

### Dispersion B2 (D8 @ 0.7 μm)

### Dispersion C1 (BON)

### Comparative Example 21

### Coating Formulation 1 Using

### Dispersion A2 (ODB-2 @ 0.2 μm)

### Dispersion B2 (DP-201 @ 0.2 μm)

### Dispersion C1 (BON)

### Comparative Example 22

### Coating Formulation 1 Using

### Dispersion A2 (ODB-2 @ 0.7 μm)

### Dispersion B2 (DP-201 @ 0.7 μm)

### Dispersion C1 (BON)

### Comparative Example 23

### Coating Formulation 1 Using

### Dispersion A2 (ODB-2 @ 0.2 μm)

### Dispersion B2 (BPA @ 0.2 μm)

### Dispersion C1 (BON)

### Comparative Example 24

### Coating Formulation 1 Using

### Dispersion A2 (ODB-2 @ 0.7 μm)

### Dispersion B2 (BPA @ 0.7 μm)

### Dispersion C1 (BON)

### Comparative Example 25

### Coating Formulation 1 Using

### Dispersion A2 (ODB-2 @ 0.2 μm)

### Dispersion B2 (BPS-MAE @ 0.2 μm)

### Dispersion C1 (BON)

### Comparative Example 26

### Coating Formulation 1 Using

### Dispersion A2 (ODB-2 @ 0.7 μm)

### Dispersion B2 (BPS-MAE @ 0.7 μm)

### Dispersion C1 (BON)

### Comparative Example 27

### Coating Formulation 1 Using

### Dispersion A2 (ODB-2 @ 0.2 μm)

### Dispersion B2 (BPS-BN @ 0.2 μm)

### Dispersion C1 (BON)

### Comparative Example 28

### Coating Formulation 1 Using

### Dispersion A2 (ODB-2 @ 0.7 μm)

### Dispersion B2 (BPS-BN @ 0.7 μm)

### Dispersion C1 (BON)

### Comparative Example 29

### Coating Formulation 1 Using

### Dispersion A2 (ODB-2 @ 0.2 μm)

### Dispersion B2 (UU @ 0.2 μm)

### Dispersion C1 (BON)

### Comparative Example 30

### Coating Formulation 1 Using

### Dispersion A2 (ODB-2 @ 0.7 μm)

### Dispersion B2 (UU @ 0.7 μm)

### Dispersion C1 (BON)

The examples were coated @ 3.0 gm/m². A topcoat was applied @ 3.5 gm/m². The examples were imaged using a barcode and solid block pattern at std speed (6 ips) and high speed (12-ips) on the default heat setting on the ZEBRA 140-401 printer. Barcode quality was tested using a TRUCHECK verifier @ 650 nm.

The solid block optical density was measured using a GRETAG densitometer. The results are in the following chart.

| | | | | 70 C 95% | | |
|---|---|---|---|---|---|---|
| | | | | RH | | |
| | INITIAL | | | 24 HRS | | |
| | ANSI | PCS | Gretag | ANSI | PCS | Gretag |
| Scan 6 inches per | | | | | | |
| second | | | | | | |
| (15.24 cm/sec) | | | | | | |
| Example 1 | A | 97 | 2.38 | A | 94 | 2.15 |
| Example 2 | A | 97 | 2.14 | F | 89 | 1.44 |
| Example 3 | A | 94 | 2.28 | C | 91 | 1.26 |
| Example 4 | A | 93 | 1.93 | D | 89 | 1.05 |
| Example 5 | A | 96 | 2.35 | F | 23 | 1.70 |
| Example 6 | A | 93 | 2.00 | F | 26 | 1.63 |
| Example 7 | A | 92 | 2.38 | D | 83 | 1.03 |
| Example 8 | B | 91 | 2.06 | F | 71 | 0.65 |
| Example 9 | A | 94 | 2.45 | B | 87 | 1.57 |
| Example 10 | A | 93 | 2.37 | B | 84 | 1.41 |
| Example 11 | A | 93 | 2.48 | F | 20 | 0.20 |
| Example 12 | A | 91 | 2.22 | F | 17 | 0.15 |
| Example 13 | A | 95 | 2.49 | F | 23 | 0.35 |
| Example 14 | A | 94 | 2.35 | F | 17 | 0.15 |
| Example 15 | D | 78 | 0.83 | F | 76 | 0.81 |
| Example 16 | F | 64 | 0.66 | F | 45 | 0.52 |
| Comparative example 1 | A | 98 | 2.39 | B | 93 | 1.87 |
| Comparative example 2 | A | 98 | 2.36 | C | 85 | 1.14 |
| Comparative example 3 | A | 95 | 2.35 | D | 87 | 1.09 |
| Comparative example 4 | A | 95 | 2.19 | D | 85 | 0.98 |
| Comparative example 5 | A | 97 | 2.39 | F | 17 | 1.48 |
| Comparative example 6 | A | 95 | 2.23 | F | 13 | 1.31 |
| Comparative example 7 | A | 94 | 2.40 | B | 84 | 1.31 |
| Comparative example 8 | A | 94 | 2.21 | D | 67 | 0.89 |
| Comparative example 9 | A | 96 | 2.48 | B | 85 | 1.48 |
| Comparative example 10 | A | 95 | 2.41 | C | 79 | 1.19 |
| Comparative example 11 | A | 95 | 2.47 | F | 17 | 0.17 |
| Comparative example 12 | A | 94 | 2.38 | F | 12 | 0.13 |
| Comparative example 13 | A | 97 | 2.47 | F | 10 | 0.12 |
| Comparative example 14 | A | 95 | 2.39 | F | 10 | 0.11 |
| Comparative example 15 | B | 83 | 1.13 | F | 84 | 1.47 |
| Comparative example 16 | C | 78 | 0.89 | F | 77 | 1.16 |
| Comparative example 17 | A | 96 | 2.34 | F | 62 | 0.65 |
| Comparative example 18 | A | 96 | 1.99 | F | 53 | 0.40 |
| Comparative example 19 | A | 96 | 2.38 | F | 19 | 1.38 |
| Comparative example 20 | A | 97 | 2.39 | F | 12 | 1.29 |
| Comparative example 21 | A | 95 | 2.40 | C | 77 | 1.21 |
| Comparative example 22 | A | 94 | 2.16 | D | 63 | 0.86 |
| Comparative example 23 | A | 95 | 2.44 | B | 85 | 1.48 |
| Comparative example 24 | A | 95 | 2.39 | C | 84 | 1.56 |
| Comparative example 25 | A | 97 | 2.47 | F | 12 | 0.12 |
| Comparative example 26 | A | 96 | 2.40 | F | 12 | 0.13 |
| Comparative example 27 | A | 97 | 2.47 | F | 42 | 0.32 |
| Comparative example 28 | A | 97 | 2.39 | F | 36 | 0.21 |
| Comparative example 29 | C | 82 | 1.13 | F | 78 | 1.07 |
| Comparative example 30 | C | 78 | 0.80 | F | 69 | 0.74 |
| Scan 12 inches per | | | | | | |
| second | | | | | | |
| (30.48 cm/sec) | | | | | | |
| Example 1 | A | 96 | 2.28 | B | 92 | 1.78 |
| Example 2 | F | 91 | 1.49 | F | 64 | 0.49 |
| Example 3 | D | 90 | 1.20 | F | 70 | 0.61 |
| Example 4 | F | 89 | 1.12 | F | 63 | 0.48 |
| Example 5 | B | 95 | 2.06 | F | 20 | 1.16 |
| Example 6 | D | 92 | 1.66 | F | 18 | 0.90 |
| Example 7 | C | 90 | 1.63 | F | 73 | 0.64 |
| Example 8 | F | 86 | 1.58 | F | 58 | 0.41 |
| Example 9 | A | 92 | 2.18 | D | 82 | 1.08 |
| Example 10 | B | 91 | 1.98 | F | 73 | 0.89 |
| Example 11 | B | 90 | 1.80 | F | 21 | 0.18 |
| Example 12 | C | 88 | 1.73 | F | 15 | 0.15 |
| Example 13 | B | 93 | 2.05 | F | 15 | 0.14 |
| Example 14 | C | 91 | 1.95 | F | 13 | 0.13 |
| Example 15 | F | 73 | 0.62 | F | 69 | 0.58 |
| Example 16 | F | 49 | 0.44 | F | 30 | 0.32 |
| Comparative example 1 | A | 96 | 2.29 | D | 83 | 1.05 |
| Comparative example 2 | A | 95 | 2.19 | F | 71 | 0.44 |
| Comparative example 3 | B | 91 | 1.56 | F | 63 | 0.50 |
| Comparative example 4 | B | 91 | 1.49 | F | 54 | 0.41 |
| Comparative example 5 | A | 96 | 2.19 | F | 0 | 1.15 |
| Comparative example 6 | B | 95 | 1.92 | F | 0 | 1.16 |
| Comparative example 7 | A | 93 | 1.87 | F | 58 | 0.69 |
| Comparative example 8 | C | 91 | 1.79 | F | 53 | 0.66 |
| Comparative example 9 | A | 95 | 2.21 | F | 70 | 1.02 |
| Comparative example 10 | A | 94 | 2.20 | F | 68 | 0.92 |
| Comparative example 11 | B | 93 | 2.04 | F | 17 | 0.16 |
| Comparative example 12 | A | 94 | 2.18 | F | 15 | 0.14 |
| Comparative example 13 | A | 95 | 2.19 | F | 10 | 0.10 |
| Comparative example 14 | A | 93 | 2.13 | F | 9 | 0.10 |
| Comparative example 15 | D | 77 | 0.78 | F | 77 | 1.07 |
| Comparative example 16 | F | 60 | 0.63 | F | 60 | 0.87 |
| Comparative example 17 | C | 90 | 1.34 | F | 34 | 0.18 |
| Comparative example 18 | D | 89 | 1.27 | F | 31 | 0.18 |
| Comparative example 19 | B | 95 | 2.09 | F | 0 | 1.25 |
| Comparative example 20 | C | 93 | 1.79 | F | 0 | 1.23 |
| Comparative example 21 | B | 91 | 1.73 | F | 41 | 0.38 |
| Comparative example 22 | D | 89 | 1.65 | F | 37 | 0.30 |
| Comparative example 23 | A | 93 | 2.20 | F | 61 | 0.76 |
| Comparative example 24 | B | 93 | 2.03 | F | 54 | 0.69 |
| Comparative example 25 | B | 92 | 2.04 | F | 12 | 0.13 |
| Comparative example 26 | B | 91 | 1.89 | F | 9 | 0.09 |
| Comparative example 27 | B | 93 | 2.12 | F | 11 | 0.13 |
| Comparative example 28 | B | 92 | 2.06 | F | 9 | 0.10 |
| Comparative example 29 | F | 76 | 0.76 | F | 73 | 0.71 |
| Comparative example 30 | F | 53 | 0.58 | F | 50 | 0.52 |

PCS is also read from the TRUCHECK verifier instrument. The verifier is calibrated to ANSI (American National Standards Institute) Bar Code Print Quality Guideline, X3.182 published 1990. The ANSI guideline defines eight categories of print quality that are measured. The output of the ANSI method is a grade for the bar code A, B, C, D or F based on measurements in each category. Bar codes rated C or better should scan with most properly maintained scanners on the first pass.

Users often specify grade B or better codes for their labels or packaging to provide an extra margin of error to avoid problems with potential misreads. The ANSI bar code print quality grading method is a measure of the relationship between the printed symbol and the ability of a bar code scanner to interpret the symbol.

In the above table, example 1 illustrates the invention. Note that the ANSI grading for Example 1 at 70° C. 95% Relative Humidity 24 hours test exceeds all other examples and comparatives. Example 1 is the system according to the invention. Comparative example 1 adds sensitizer. Note ANSI performance substantially degrades for all combinations with the exception of Example 1. Comparative example 17 adds a different sensitizer. Similarly, example 2 illustrates different imaging chemistry commonly used. Comparative example 2 adds sensitizer. Comparative example 18 substitutes a different sensitizer for further comparison purposes. Example 1 illustrates the invention. The balance of the examples illustrate alternative chemistries without sensitizer and with sensitizer.

All documents cited in the specification herein are, in relevant part, incorporated herein by reference for all jurisdictions in which such incorporation is permitted. The citation of any publication is for its disclosure prior to the filing date and should not be construed as an admission that such publication is prior art or that the present invention is not entitled to antedate such publication by virtue of prior invention. To the extent that any meaning or definition of a term in this document conflicts with any meaning or definition of the same term in a document incorporated by reference, the meaning or definition assigned to that term in this document shall govern.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “0.2 micron” is intended to mean “about 0.2 micron”.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. Any description of certain embodiments as “preferred” embodiments, and other recitation of embodiments, features, or ranges as being preferred, or suggestion that such are preferred, is not deemed to be limiting. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention. No unclaimed language should be deemed to limit the invention in scope. Any statements or suggestions herein that certain features constitute a component of the claimed invention are not intended to be limiting unless reflected in the appended claims.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A thermally-responsive record material useful for bar coding comprising a support having provided thereon in substantially contiguous relationship a heat sensitive coating comprising at least one chromogenic material, said chromogenic material being selected from a fluoran, and at least one developer of formula (II) 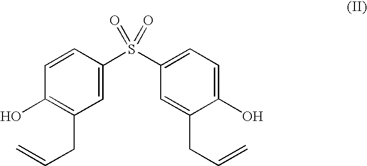
wherein the chromogenic material and developer are of an average particle size of less 5×10⁻⁷ meters or less, wherein the composition is substantially free of sensitizer or modifier.

2. The thermally-responsive record material according to claim 1 wherein the particle size of the chromogenic material and the developer is of an average particle size of 0.2 μm or less.

3. The thermally-responsive record material according to claim 1 wherein the heat sensitive coating comprises one or more layers and the chromogenic material and developer are in the same layer or each is independently in a layer of the one or more layers.

4. The thermally-responsive record material according to claim 1 wherein the chromogenic material is selected from 3-diethylamino-6-methyl-7anilino-fluoran, 3-dibutylamino-7-(2-chloroanilino) fluoran, 7-(1-ethyl-2-methylindol-3-yl)-7-(2-chloroanilino)fluoran, 3-(N-methylcyclohexylamino)-6-methyl-7-anilinofluoran, 3-diethylamino-7-anilinofluoran; 3-diethylamino-7-benzylaminofluoran, 2,4-dimethyl-6[4-dimethylamino)aniline]-fluoran, 2-anilino-3-methyl-6-dibutylaminofluoran, and mixtures the foregoing.

5. A thermally-responsive record material useful for bar coding comprising a support having provided thereon in substantially contiguous relationship a heat sensitive coating comprising at least one chromogenic material, said chromogenic material being selected from compounds of the formula (I) 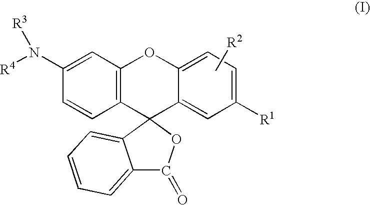
wherein R¹ comprise amino-, hydrogen, alkyl having less than nine carbons, anilino, anilino substituted with halogen, acetamido, or halogen;
wherein R² comprises hydrogen, or C1 to C8 alkyl;
wherein R³ and R⁴ each independently comprise hydrogen, dialkylaminoaryl, alkaryl, cycloalkyl, or C1 to C8 alkyl
and at least one developer of the formula (II) 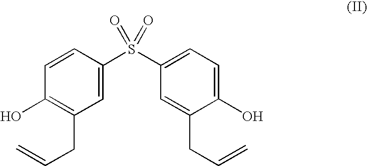
wherein the chromogenic material and developer are of an average particle size of less than 0.7 μm,
wherein the composition is substantially free of sensitizer or modifier.
and, includes a binder material.

6. The record material according to claim 3 wherein the particle size of the chromogenic material and the developer is of an average particle size of 0.2 μm or less.

7. The record material according to claim 3 wherein the fluoran is selected from 3-diethylamino-6-methyl-7-anilino-fluoran, 3-dibutylamino-7-(2-chloroanilino) fluoran, 7-(1-ethyl-2-methylindol-3-yl)-7-(2-chloroanilino) fluoran, 3-(N-methylcyclohexylamino)-6-methyl-7-anilinofluoran, 3-diethylamino-7-anilinofluoran; 3-diethylamino-7-benzylaminofluoran, 2,4-dimethyl-6[(4-dimethylamino)aniline]-fluoran, 2-anilino-3-methyl-6-dibutylaminofluoran, and mixtures the foregoing.

8. The thermally-responsive record material according to claim 3 wherein the heat sensitive coating comprises one or more layers and the chromogenic material and developer are in the same layer or each is independently in a layer of one or more layers.

9. A thermally responsive record material useful for bar coding comprising a support having provided thereon in substantially contiguous relationship a heat-sensitive coating comprising:
a substantially colorless dye precursor 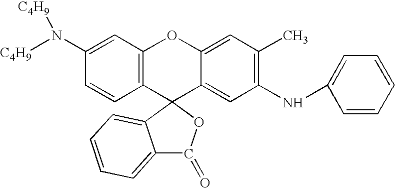
and at least one developer of the formula (II) 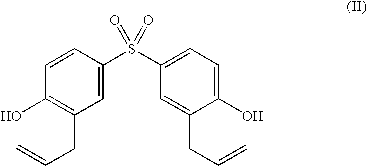
wherein the chromogenic material and developer are of an average particle size of 0.7 μm or less, wherein the composition is free of sensitizer or modifier.

10. The record material according to claim 9 wherein the particle size of the chromogenic material and the developer is of an average particle size of 0.2 μm or less.
